(19) United States
(12) Patent Application Publication
(10) Pub. No.: US 2006/0097649 A1
(43) Pub. Date: May 11, 2006

(54) Plasma display apparatus

(76) Inventors: Won Tae Kim, Gumi-si (KR); Gi Bum Lee, Changwon-si (KR); Yun Gi Kim, Busan-si (KR); Jin Young Kim, Daegu-si (KR)

Correspondence Address: FLESHNER & KIM, LLP, P.O. BOX 221200, CHANTILLY, VA, 20153, US

(21) Appl. No.: 11/268,736

(22) Filed: Nov. 8, 2005

(30) Foreign Application Priority Data
Nov. 9, 2004 (KR) 10-2004-0090964

(51) Int. Cl. G09G 3/10

(52) U.S. Cl. 315/169.4

(57) ABSTRACT

A plasma display apparatus comprises a plurality of upper electrodes formed on an upper substrate, a plurality of lower electrodes formed on a lower substrate facing the upper substrate and crossing the upper electrodes, and barrier ribs separating a plurality of discharge cells formed between the upper and lower substrates. The discharge cell is formed such that a horizontal width of at least one of an upper or lower portion thereof is smaller than that of a central portion thereof.

### BACKGROUND OF THE INVENTION

1. Field of the Invention

The present invention relates to a plasma display apparatus and, more particularly, to a plasma display apparatus capable of reducing panel capacitance by improving a shape of discharge cells so as to be driven according to a single scan method.

2. Description of the Related Art

A plasma display apparatus is an apparatus in which discharge cells are formed between a lower substrate with barrier ribs formed thereon and an upper substrate facing the lower substrate, and when an inert gas inside each discharge cell is discharged by a high frequency voltage, vacuum ultraviolet rays are generated to illuminate phosphor to thereby allow displaying of images.

FIG. 1 is a plan view of electrodes formed in a general plasma display apparatus, and FIG. 2 is a sectional view showing a discharge cell of the general plasma display apparatus.

First, discharge cells are formed by a plurality of barrier ribs 24 separating a discharge space on a lower substrate 18 facing an upper substrate 10.

An address electrode 12X is formed on the lower substrate 18, and a scan electrode 12Y and a sustain electrode 12Z are formed as a pair on the upper substrate 10. The address electrode 12X crosses the other electrodes, and in this respect, the upper substrate 10 in FIG. 1 is shown as having been rotated by 90° for the sake of explanation.

A dielectric layer 22 for accumulating wall charges is formed on the lower substrate 18 with the address electrode 12 formed thereon.

Barrier ribs 24 are formed on the dielectric layer 22 to define a discharge space therebetween and prevent a leakage of ultraviolet rays and visible light generated by a discharge to an adjacent discharge cell. Phosphor 26 is coated on the surface of the dielectric layer 22 and on the surface of the barrier ribs 24.

Because an inert gas is injected into the discharge space, the phosphor 26 is excited by the ultraviolet rays generated during a gas discharge to generate one of red, green and blue visible light.

The scan electrode 12Y and the sustain electrode 12Z formed on the upper substrate 10 comprise a transparent electrode 12a and a bus electrode 12b, respectively, and cross the address electrode 12X. A dielectric layer 14 and a protective film 16 are formed to cover the scan electrode 12Y and the sustain electrode 12Z.

The discharge cell with such a structure is selected by a facing discharge formed between the address electrode 12X and the scan electrode 12Y, and a discharge is sustained by a surface discharge between the scan electrode 12Y and the sustain electrode 12Z, to thus emit visible light. The scan electrode 12Y and the sustain electrode 12Z comprise the transparent electrode 12a and the bus electrode 12b having the smaller width than the transparent electrode 12a and formed on one edge portion of the transparent electrode 12a, respectively.

However, the related art plasma display apparatus has the following problem. That is, as the resolution of the panel is increasingly improved and the panel is being enlarged in size, time for scanning the address electrodes is lengthened. In addition, as the length of each electrode and the number of electrode lines increase in line with the enlargement of the panel, panel parasitic capacitance is also increased to make the plasma display apparatus consume more power.

In an effort to solve such a problem, as shown in FIG. 3, a method for driving the large-scale plasma display apparatus according to a dual scan method has been proposed.

With reference to FIG. 3, a dual scan type plasma display apparatus comprises two address drivers 31 and 32 for driving address electrodes in a dual scan manner, a scan driver 40 for driving scan electrodes, and a sustain driver 4 for driving sustain electrodes.

The first address driver 31 applies a data signal to drive a first address electrode group (X1₁ to X1ₘ) of a display panel 60 to output an image on an upper screen, and the second address driver 32 applies a data signal to drive a second address electrode group (X2₁ to X2ₘ) of the display panel 60 to output an image on a lower screen.

As shown in FIG. 4, the scan driver 40 can divide the scan electrodes (Y₁ to Yₙ) into two groups (Y₁ to Y_{n/2} and Y_{n/2+1} to Yₙ) and sequentially applies a scan pulse to electrodes of each group simultaneously, to thereby reduce an address period to ½.

The dual scan type plasma display apparatus is, however, disadvantageous in that more data driver integrated circuits are required to be mounted in each of the address drivers 31 and 32 compared with a single scan type plasma display apparatus, resulting in an increase in the cost, and power consumption is also increased due to the parasitic capacitance of the panel.

### SUMMARY OF THE INVENTION

The present invention is designed to solve such problem of the related art, and therefore, an object of the present invention is to provide a plasma display apparatus capable of reducing panel capacitance by improving a shape of discharge cells so as to be driven according to a single scan method.

To achieve the above object, there is provided a plasma display apparatus comprising a plurality of upper electrodes, a plurality of lower electrodes and barrier ribs. The plurality of upper electrodes are formed on an upper substrate. The plurality of lower electrodes are formed on a lower substrate facing the upper substrate, crossing the upper electrodes. The barrier ribs separate a plurality of discharge cells formed between the upper substrate and the lower substrate. The discharge cell is formed such that a horizontal width of one of an upper and a lower portion thereof is different from that of a central portion thereof.

Herein, the discharge cell can have rounded corner portions.

The discharge cell can be formed such that the horizontal width narrows as it goes from the central portion to the upper or lower portion.

The upper or lower horizontal width of the discharge cell may be 90% or greater but smaller than 100% of the horizontal width of the central portion of the discharge cell.

The upper electrode comprises a scan electrode, and can be driven by a single scan driving method in which a scan pulse is applied to each of a plurality of scan electrodes formed on a display region of the upper substrate at each different time, respectively.

To achieve the above object, there is also provided a plasma display apparatus comprising a plurality of upper electrodes, a plurality of lower electrodes and barrier ribs. The plurality of upper electrodes are formed on an upper substrate. The plurality of lower electrodes are formed on a lower substrate facing the upper substrate, crossing the upper electrodes. The barrier ribs separate a plurality of discharge cells formed between the upper substrate and the lower substrate. The discharge cell is formed such that a vertical width of one of a left and a right portion thereof is different from that of a central portion thereof.

To achieve the above object, there is also provided a plasma display apparatus comprising a plurality of scan electrodes, barrier ribs and a scan driver. The plurality of scan electrodes are formed on an upper substrate. The barrier ribs are formed on a lower substrate facing an upper substrate. The scan driver applies a scan pulse to the scan electrodes. Discharge cells separated by the barrier ribs are formed such that a horizontal width or a vertical width of an outer portion thereof is different from that of a central portion thereof, and the scan driver applies the scan pulse to the plurality of scan electrodes at each different time, respectively.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a plan view showing electrodes formed on a plasma display apparatus in accordance with a related art.

FIG. 2 is a sectional view showing a discharge cell of the plasma display apparatus in accordance with the related art.

FIG. 3 is a view showing a general dual scan type plasma display apparatus.

FIG. 4 is a view showing a scan pulse of the general dual scan type plasma display apparatus.

FIG. 5 illustrates a first application example of a discharge cell in accordance with the present invention.

FIG. 6 illustrates a second application example of the discharge cell in accordance with the present invention.

FIG. 7 illustrates a third application example of the discharge cell in accordance with the present invention.

FIG. 8 illustrates a fourth application example of the discharge cell in accordance with the present invention.

FIG. 9 illustrates a fifth application example of the discharge cell in accordance with the present invention.

FIG. 10 is a view showing the exemplary construction of a single scan type plasma display apparatus in accordance with the present invention.

FIG. 11 is a view showing a scan pulse of the general dual scan type plasma display apparatus.

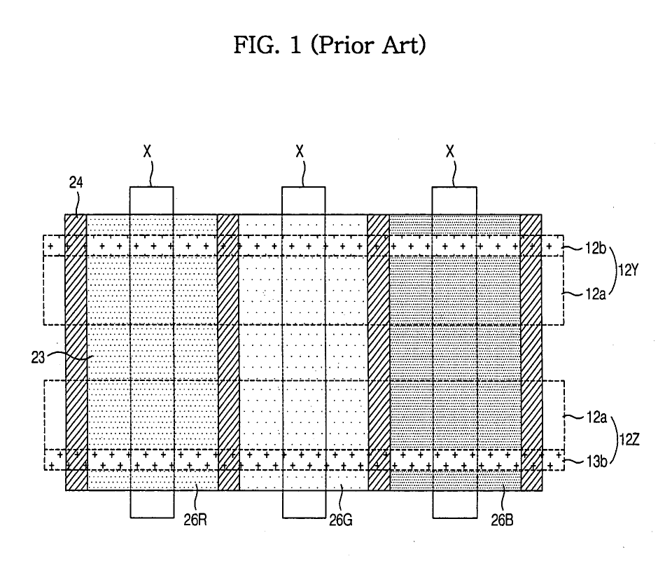

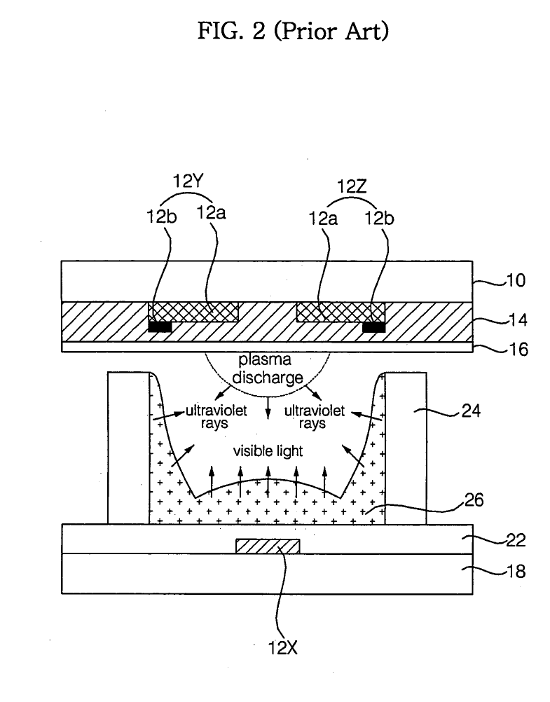

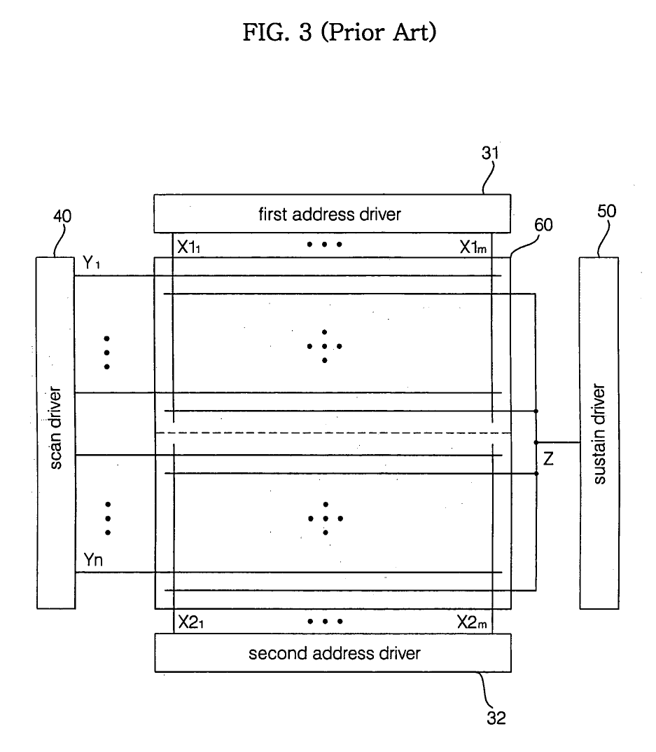

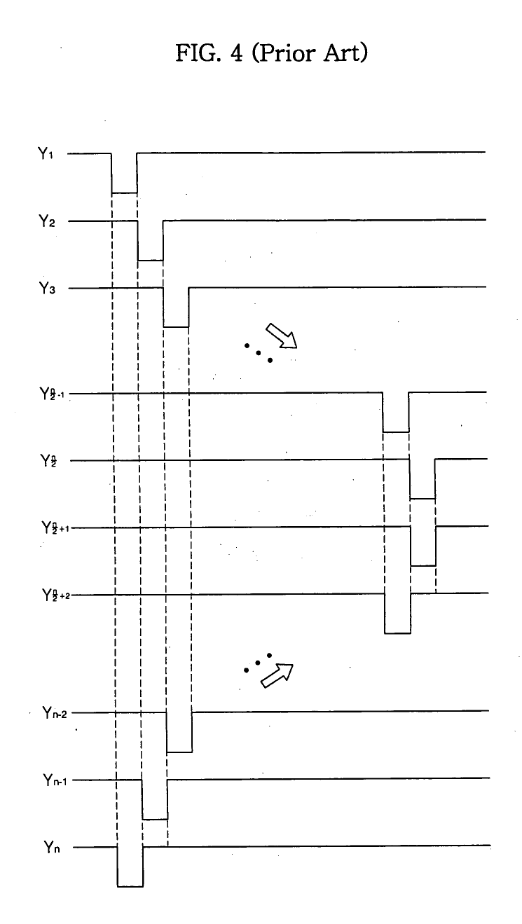

### DETAILED DESCRIPTION OF THE PREFERRED EMBODIMENT

A plasma display apparatus in accordance with the preferred embodiments of the present invention will now be described with reference to the accompanying drawings.

There can be a plurality of embodiments of the plasma display panel in accordance with the present invention without being limited to those described in the present invention.

The plasma display apparatus in accordance with the present invention comprises a plurality of upper electrodes formed on an upper substrate, a plurality of lower electrodes formed on a lower substrate facing the upper substrate and crossing the upper electrodes, and barrier ribs separating a plurality of discharge cells formed between the upper substrate and the lower substrate. As for the discharge cells, a horizontal width of at least one of an upper portion and a lower portion of the discharge cell is different from that of a central portion of the discharge cell.

The plurality of upper electrodes are formed on the upper substrate, on which a dielectric layer is stacked to cover the upper electrodes.

In order to prevent the dielectric layer from being damaged due to a discharge, a protective film is formed on the surface of the dielectric layer.

A lower electrode is formed on the lower substrate which faces the upper substrate to form a discharge therebetween, and a dielectric layer is stacked to cover the lower electrode. In addition, barrier ribs 70a and 70b separating the discharge cells 60 are formed on the dielectric layer. Herein, the barrier ribs 70a and 70b comprise the horizontal barrier rib 70a and the vertical barrier rib 70b, constituting a closed type barrier rib form.

The lower electrode comprises an address electrode.

The lower electrode is formed in a direction that it crosses the upper electrode.

The upper electrode comprises a scan electrode and a sustain electrode, and each electrode comprises a transparent electrode and a metallic bus electrode having a width smaller than that of the transparent electrode and formed on one edge portion of the transparent electrode.

The transparent electrode includes a metal such as an indium tin oxide (ITO), an indium zinc oxide (IZO) or an indium tin zinc oxide (ITZO), and the metallic bus electrode typically made of chrome (Cr) is formed on the transparent electrode and serves to reduce a voltage drop by the transparent electrode having high resistance.

The dielectric layer is formed to cover the electrodes formed on the upper and lower substrates.

The protective film includes magnesium oxide (MgO), prevents the dielectric layer from being damaged by sputtering generated when a plasma discharge occurs, and increases the efficiency of emission of secondary electrons. Accordingly, the dielectric layer and the protective film can serve to lower a discharge firing voltage.

The barrier ribs 70a and 70b form the discharge space together with the upper and lower substrates and prevent a leakage of vacuum ultraviolet rays generated according to a gas discharge to an adjacent discharge cell.

The discharge space may be filled with an inert gas such as He, Ne, Ar, Xe, Kr, etc., for a gas discharge, a discharge gas of a mixture thereof, or an excimer gas that can generate ultraviolet rays according to the discharge.

A phosphor layer is coated on the side surface of the barrier ribs 70a and 70b or on the surface of the dielectric layer within the discharge space and excited by the vacuum ultraviolet rays (VUV) generated when the plasma discharge occurs, to emit one of red (R), green (G) and blue (B) visible light.

The horizontal barrier rib 70a is formed to be parallel to the scan electrode and the sustain electrode on the lower substrate.

The vertical barrier rib 70b is formed to be parallel to the address electrode on the lower substrate.

A unit discharge cell separated by the horizontal and vertical barrier ribs 70a and 70b will be described in detail based on its shape viewed from the upper substrate.

The unit discharge cell has a horizontal width and a vertical width, and in this case, a horizontal width of at least one of an upper portion or a lower portion of the discharge cell is smaller than that of a central portion of the discharge cell.

Namely, the portion of the discharge cell contacting with the horizontal barrier rib is narrower than the central portion of the central portion (e.g., the distance between the horizontal barrier ribs) of the discharge cell.

With such a structure, the width of the portion where the horizontal barrier rib and the horizontal rib cross can be extended, and thus, capacitance according to the barrier ribs can be reduced.

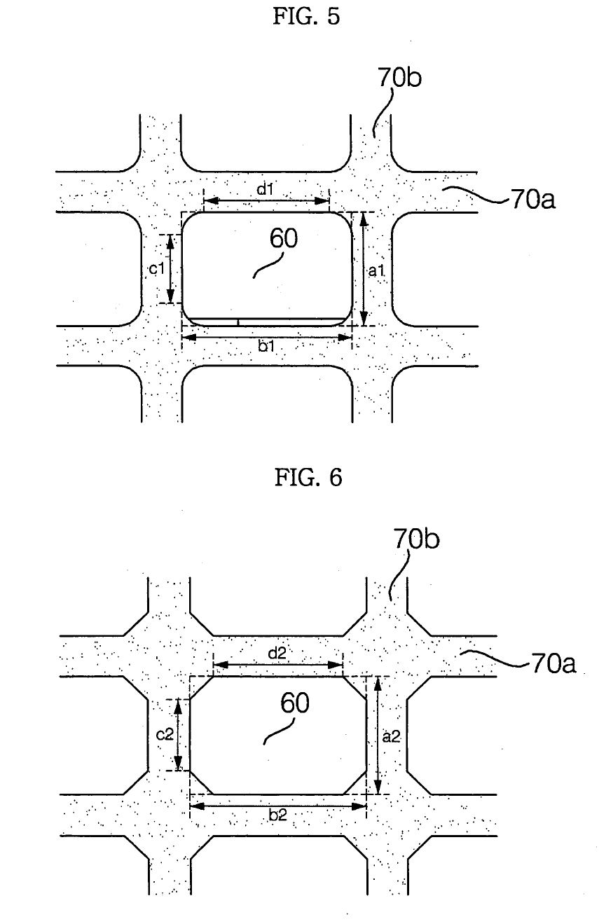

FIG. 5 illustrates first and fourth embodiments of the present invention and FIGS. 6 to 9 illustrate various application examples of the discharge cell in accordance with second and fifth embodiments of the present invention.

To begin with, FIG. 5 shows the first embodiment of the present invention in which a discharge cell has symmetrical upper and lower portions. That is, in the plasma display apparatus in accordance with the first embodiment of the present invention, at least one of the upper portion and lower portion of the discharge cell has rounded corners.

Though it is shown that both the upper portion and the lower portion of the discharge cell have the symmetrically rounded corners, it can be also possible that only one side of the upper portion and lower portion of the discharge cell can have the rounded corners.

Namely, since the upper and lower corner portions of the discharge cell have the round shape with a certain radius of curvature, the width of the barrier rib at both corner portions can be lengthened to make the barrier rib thick.

With such rounded corners, the horizontal width (d1) of the upper portion or the lower portion of the discharge cell can be smaller than the horizontal width (b1) of the central portion of the discharge cell.

FIGS. 6 to 9 show various application examples of the discharge cell with symmetrical upper and lower portions in accordance with the second embodiment of the present invention. A plasma display apparatus in accordance with the second embodiment of the present invention has a structure in that the discharge cell is formed such that its horizontal width narrows as it goes from the central portion thereof to the upper portion or the lower portion thereof.

With reference to FIG. 6, the discharge cell sustains the same horizontal width (b2) of the central portion from the central portion to a certain portion, and becomes gradually narrow from the certain portion to reach a certain size (d2) of the horizontal width at an outermost upper portion or lower portion.

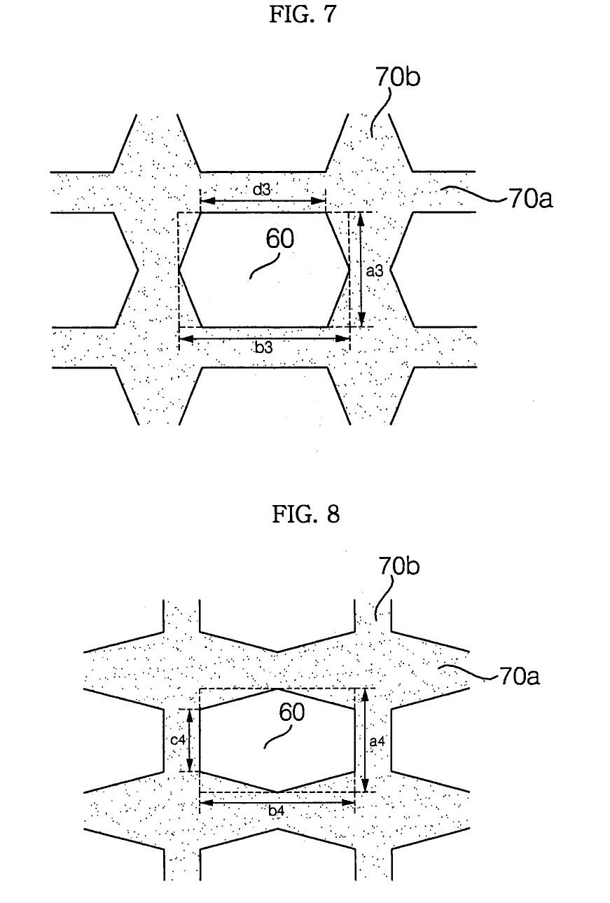

With reference to FIG. 7, the horizontal width (b3) of the discharge cell is reduced starting from the central portion and gradually reduced as it goes to the upper portion or the lower portion of the discharge cell to finally have a certain size (d3) of the horizontal width at the outermost upper or lower portion of the discharge cell.

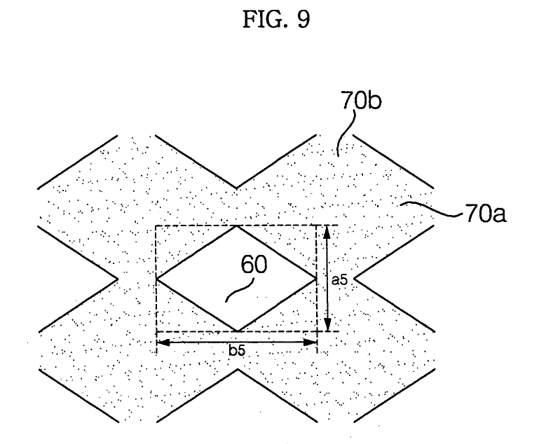

With reference to FIG. 8, the horizontal width (b4) of the central portion of the discharge cell is sustained from the central portion up to a certain portion, and becomes gradually narrow as it goes from the certain portion to the upper portion or the lower portion to end in convergence of the left and right vertical barrier ribs of the discharge cell.

With reference to FIG. 9, the width (b5) of the discharge cell is reduced starting from the central portion toward the upper portion or the lower portion of the discharge cell to end in convergence of the left and right vertical barrier ribs of the discharge cell.

Herein, the second embodiment of the present invention may include a case where the horizontal width of the discharge cell is not linearly reduced but reduced by several stages as it goes to the upper portion or the lower portion, making the corner portions of the discharge cell have an irregular shape.

The first and second embodiments of the present invention may include a case where the discharge cell has such asymmetrical shape that the horizontal width of the upper portion of the discharge cell is not the same as that of the lower portion of the discharge cell.

A plasma display apparatus in accordance with a third embodiment of the present invention has a structure in that the horizontal width of the upper portion or the lower portion of the discharge cell is 90% or greater but smaller than 100% of that of the central portion of the discharge cell.

That is, with reference to FIGS. 5 to 7, the horizontal widths (d1, d2 and d3) of the upper portion or the lower portion of the discharge cell may be 90% or greater or smaller than 100% of that of the horizontal widths (b1, b2 and b3) of the central portion of the discharge cell.

In this case, if the horizontal width of the upper portion of the discharge cell is smaller than 90% of the horizontal width of the central portion in order to reduce the area of the discharge cell and increase the width of the barrier ribs, capacitance of the panel could be lowered but since the area of the discharge cell is reduced, the area of the phosphor layer coated inside the discharge cell is also reduced to cause a problem that the luminance of the panel is reduced.

In particular, if the horizontal width of the upper portion of the discharge cell is smaller than 90% of the horizontal width of the central portion, picture quality degradation occurs such that it would be perceived by a user.

In accordance with another aspect of the present invention, the plasma display apparatus in accordance with the present invention comprises a plurality of upper electrodes formed on an upper substrate, a plurality of lower electrodes formed on a lower substrate facing the upper substrate and crossing the upper electrodes, and barrier ribs separating a plurality of discharge cells formed between the upper substrate and the lower substrate. As for the discharge cells, a vertical width of at least one of a left portion and a right portion of the discharge cell is different from that of a central portion of the discharge cell.

FIG. 5 shows the fourth embodiment of the present invention in which the discharge cell has symmetrical left and right portions. That is, in the plasma display apparatus in accordance with the fourth embodiment of the present invention, at least one of the left portion and the right portion of the discharge cell has rounded corners.

Though it is shown that both the left portion and the right portion of the discharge cell have the symmetrically rounded corners, it can be also possible that only one side of the left portion and right portion of the discharge cell can have the rounded corners.

Namely, since the left and right corner portions of the discharge cell have the round shape with a certain radius of curvature, the width of the barrier rib at both corner portions can be lengthened to make the barrier rib thick.

With such rounded corners, the vertical width (c1) of the left portion or the right portion of the discharge cell is smaller than the vertical width (a1) of the central portion of the discharge cell.

FIGS. 6 to 9 show various application examples of the discharge cell with symmetrical left and right portions in accordance with the fifth embodiment of the present invention. A plasma display apparatus in accordance with the fifth embodiment of the present invention has a structure in that the discharge cell is formed such that its horizontal width narrows as it goes from the central portion thereof to the left portion or the right portion thereof.

With reference to FIG. 6, the discharge cell sustains the same horizontal width (a2) of the central portion from the central portion to a certain portion, and becomes gradually narrow from the certain portion to reach a certain size (c2) of the vertical width at an outermost left portion or right portion.

With reference to FIG. 7, the discharge cell sustains the same vertical width (a3) of the central portion from the central portion to the certain portion, and becomes gradually narrow as it goes to the left portion or to the right portion of the discharge cell to end in convergence of the upper and lower horizontal barrier ribs of the discharge cell.

With reference to FIG. 8, the vertical width (a4) of the discharge cell is reduced starting from the central portion gradually as it goes to the left portion or the right portion of the discharge cell to finally have a certain size (c4) of the vertical width at the left or right portion of the discharge cell.

With reference to FIG. 9, the width (a5) of the discharge cell is reduced starting from the central portion gradually as it goes to the left portion or the right portion of the discharge cell to end in convergence of the upper and lower horizontal barrier ribs of the discharge cell.

Herein, the second embodiment of the present invention may include a case where the vertical width of the discharge cell is not linearly reduced but reduced by several stages as it goes to the left portion or the right portion, making the corner portions of the discharge cell have an irregular shape.

The fourth and fifth embodiments of the present invention may include a case where the discharge cell has such an asymmetrical shape that the vertical width of the left portion of the discharge cell is not the same as that of the right portion of the discharge cell.

A plasma display apparatus in accordance with a sixth embodiment of the present invention has a structure in that the vertical width of the left portion or the right portion of the discharge cell is 80% or greater but smaller than 100% of that of the central portion of the discharge cell.

That is, with reference to FIGS. 5, 6 and 8, the vertical widths (c1, c2 and c4) of the upper portion or the lower portion of the discharge cell may be 80% or greater or smaller than 100% of that of the vertical widths (a1, a2 and a4) of the central portion of the discharge cell.

The reason for the limitation of the range is because, as stated above in the first and second embodiments of the present invention, if the area of the discharge cell is reduced, the panel capacitance would be lowered to advantageously reduce power consumption, but the panel luminance would be degraded.

In particular, if the vertical width of the upper portion of the discharge cell is smaller than 90% of the horizontal width of the central portion, picture quality degradation occurs such that it would be perceived by the user.

That is, as described above in the first to sixth embodiments of the present invention, in the plasma display apparatus, by forming the discharge cell separated by the barrier ribs such that its outer horizontal width is 90% or greater but smaller than 100% of the central horizontal width, or by forming the discharge cell such that its outer vertical width is 80% greater but smaller than 100% of the central vertical width, a value of the parasitic capacitance generated by the address electrode can be reduced.

In accordance with still another aspect of the present invention, the plasma display apparatus in accordance with the present invention comprises the plurality of scan electrodes formed on the upper substrate, the barrier ribs formed on the lower substrate facing the upper substrate, and the scan driver for applying the scan pulse to the scan electrodes. The discharge cells separated by the barrier ribs are formed such that the horizontal width or vertical width of an outer portion of the discharge cell is different from the horizontal width or the vertical width of the central portion of the discharge cell, and the scan driver applies the scan pulse to the plurality of scan electrodes at each different time, respectively, according to the single scan method.

According to each embodiment of the present invention, because the value of the parasitic capacitance of the panel is reduced, an address current proportional thereto is also reduced, and accordingly, power consumption of the data driver integrated circuit can be also reduced.

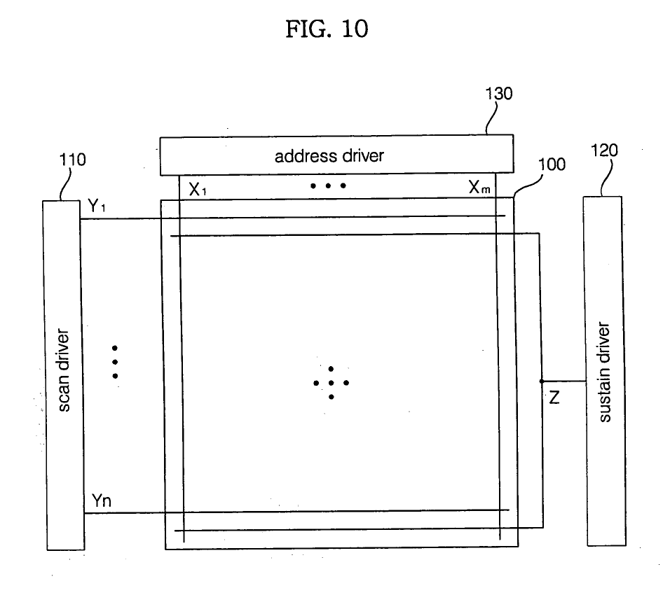

FIG. 10 illustrates an exemplary construction of a single scan type plasma display apparatus in accordance with the present invention.

Since the data driver integrated circuit consumes less power, the plasma display apparatus having the above-described structure of the barrier ribs can be driven according to the single scan driving method by using drivers 110, 120 and 130 as shown in FIG. 10.

As shown in FIG. 10, the plasma display apparatus comprises a scan driver 110 for driving scan electrodes Y1˜Yn of the panel 100, a sustain driver 120 for driving a sustain electrode (Z) of the panel 100, and an address driver 130 for driving address electrodes X1˜Xn of the panel 100.

The scan driver 110 initializes the entire wall charges of the panel 100 by using a lamp waveform during a reset period under the control of a timing controller (not shown).

Next, the scan driver 110 sequentially applies a negative scan pulse to the scan electrodes Y1˜Yn during an address period to scan signals applied to the address electrode.

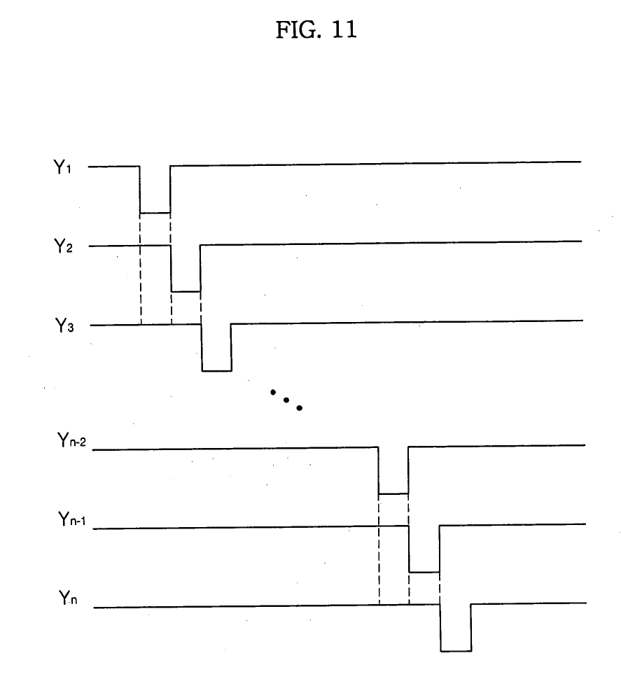

FIG. 11 illustrates the scan pulse applied to each of scan electrodes Y1˜Yn during the address period.

As shown in FIG. 11, the scan driver 110 employs the single scan method to apply the scan pulse to the plurality of scan electrodes at each different time, respectively.

The plasma display apparatus may be applied to a case where the number of scan electrode lines formed on the display region exceeds 480.

Herein, the number of the scan electrode lines on the display region refers to the scan electrodes lines positioned only at the portion of a screen where image information is actually outputted.

The plasma display apparatus in accordance with the present invention is driven according to the single scan method, and the discharge cell separated by the barrier ribs is formed such that the horizontal width or vertical width of the outer portion of the discharge cell is different from that of the central portion of the discharge cell. Preferably, the discharge cell separated by the barrier ribs is formed such that the horizontal width or vertical width of the outer portions of the discharge cell is smaller than that of the central portion of the discharge cell.

As for the shape of the barrier ribs, its detailed embodiment is substantially the same as in the first to sixth embodiments of the present invention as mentioned above.

As described above, the plasma display apparatus in accordance with the present invention has the following advantages.

In case of employing the single scan method is used, although the panel is so large as to have the number of scan electrode lines of 480 or more, since the discharge cell separated by the barrier ribs is formed such that the horizontal width or the vertical width of the outer portions of the discharge cell is smaller than the horizontal or the vertical width of the central portion of the discharge cell to thereby reduce the parasitic capacitance of the panel, it can be sufficiently driven only by one address driver.

In particular, the present invention can be favorably applicable to a panel of XGA class, namely, which has 768 or more scan lines and generally requires more data drivers because it cannot be driven by the only data driver formed at the upper side or at the lower side of the panel. That is, by adopting the present invention, such a large panel having 768 or more scan lines can be driven by only one data driver formed either at the upper side or at the lower side of the panel. Herein, the region where the 768 scan lines are formed refers to a display region.

The foregoing description of the preferred embodiments of the present invention has been presented for the purpose of illustration and description. It is not intended to be exhaustive or to limit the invention to the precise form disclosed, and modifications and variations are possible in light of the above teachings or may be acquired from practice of the invention. It is intended that the scope of the invention be defined by the claims appended hereto and their equivalents.

What is claimed is:

1. A plasma display apparatus comprising:
a plurality of upper electrodes formed on an upper substrate;
a plurality of lower electrodes formed on a lower substrate facing the upper substrate and crossing the upper electrodes; and
barrier ribs for separating a plurality of discharge cells formed between the upper substrate and the lower substrate,
wherein the discharge cell is formed such that a horizontal width of at least one of an upper portion and a lower portion thereof is different from that of a central portion thereof.

2. The apparatus of claim 1, wherein the discharge cell has a rounded corner portions.

3. The apparatus of claim 1, wherein the discharge cell is formed such that a horizontal width of the central portion thereof narrows as it goes to the upper portion or the lower portion thereof.

4. The apparatus of claim 1, wherein the horizontal width of the upper or lower portion of the discharge cell is 90% or greater but smaller than 100% of that of the central portion of the discharge cell.

5. The apparatus of claim 1, wherein the upper electrode comprises a scan electrode and is driven according to a single scan driving method in which a scan pulse is applied to each of a plurality of scan electrodes formed on a display region of the upper substrate at each different time, respectively.

6. The apparatus of claim 1, wherein the upper electrode comprises the scan electrode and the number of scan electrode lines formed on a display region of the upper substrate exceeds at least 480 lines.

7. A plasma display apparatus comprising:
a plurality of upper electrodes formed on an upper substrate;
a plurality of lower electrodes formed on a lower substrate facing the upper substrate and crossing the upper electrodes; and
barrier ribs for separating a plurality of discharge cells formed between the upper substrate and the lower substrate,
wherein the discharge cell is formed such that a vertical width of at least one of a left portion and a right portion thereof is different from that of a central portion thereof.

8. The apparatus of claim 7, wherein the discharge cell has rounded corner portions.

9. The apparatus of claim 7, wherein the discharge cell is formed such that a vertical width of the central portion thereof narrows as it goes to the left portion or the right portion thereof.

10. The apparatus of claim 7, wherein the vertical width of the left or right portion of the discharge cell is 80% or greater but smaller than 100% of that of the central portion of the discharge cell.

11. The apparatus of claim 7, wherein the upper electrode comprises a scan electrode and is driven according to a single scan driving method in which a scan pulse is applied to each of a plurality of scan electrodes formed on a display region of the upper substrate at each different time, respectively.

12. The apparatus of claim 7, wherein the upper electrode comprises the scan electrode and the number of scan electrode lines formed on a display region of the upper substrate exceeds at least 480 lines.

13. A plasma display apparatus comprising:
a plurality of scan electrodes formed on an upper substrate;
barrier ribs formed on a lower substrate facing the upper substrate; and
a scan driver for applying a scan pulse to the scan electrodes,
wherein a discharge cell separated by the barrier ribs is formed such that a horizontal width or a vertical width of an outer portion thereof is different from that of a central portion thereof, and the scan driver applies the scan pulse to the plurality of scan electrodes at each different time, respectively.

14. The apparatus of claim 13, wherein scan electrode lines formed on a display region exceeds 480 lines in number.

15. The apparatus of claim 13, wherein the scan electrode lines formed on the display region is 768 or more lines in number.

16. The apparatus of claim 13, wherein the discharge cell has a rounded corner portions.

17. The apparatus of claim 13, wherein the discharge cell is formed such that the width of the discharge cell narrows as it goes from the central portion to the outer portions thereof.

18. The apparatus of claim 13, wherein the horizontal width of the outer portions of the discharge cell is 90% or greater but smaller than 100% of that of the central portion of the discharge cell.

19. The apparatus of claim 13, wherein the vertical width of the outer portions of the discharge cell is 80% or greater but smaller than 100% of that of the central portion of the discharge cell.
